(19) United States
(12) Patent Application Publication
(10) Pub. No.: US 2009/0324906 A1
(43) Pub. Date: Dec. 31, 2009

(54) SEMICONDUCTOR WITH TOP-SIDE WRAP-AROUND FLANGE CONTACT

(76) Inventor: Phil P. Marcoux, Mountain View, CA (US)

Correspondence Address: The TPL Group, 20400 Stevens Creek Blvd., Fifth Floor, Cupertino, CA, 95014, US

(21) Appl. No.: 12/147,370

(22) Filed: Jun. 26, 2008

(51) Int. Cl. B32B 3/02; B05D 5/12; C23F 1/00; B32B 37/00; B32B 37/12; B23K 1/20

(52) U.S. Cl. 428/201; 427/98.5; 427/97.4; 427/96.2; 216/13; 156/73.1; 156/196; 228/176; 428/195.1

(57) ABSTRACT

A method and apparatus are described for an electronic component package. A standoff is formed on an active side of a substrate. The substrate has an electronic circuit. A conductive layer is deposited over at least a portion of the active side of the substrate. The conductive layer electrically couples a contact area on the active side of the substrate. The standoff is removed to create a flexible conductor.

### FIELD

Embodiments of the present invention relate generally to electronic component packaging. More particularly, these embodiments relate to forming a compliant wrap-around contact on the top side of a semiconductor.

### BACKGROUND

Electronic components are packaged in order to interconnect them with other devices. The packaging of the electronic device usually includes contacts for transmitting signals and providing power and ground connections between the internal circuitry of the device and external circuitry. Some examples of prior art contacts include wire bonds protruding from the ends of a discrete diode or resistor, or metal caps located on the ends of a fuse. Sophisticated electronic devices such as microprocessors may require several hundred contacts. Those devices are usually produced in a package having multiple pins for mounting to a printed circuit board. The electronic component is typically placed in a package, and each required contact area on the electronic component is wire bonded to the corresponding pin on the package. Because each wire bond is individually added to the circuit, large numbers of contacts make wire bonding expensive. Additionally, because of the precision required for wire bonding, wire bonding may result in short circuits and similar problems. Furthermore, wire bonds can degrade chip performance because of the length of the wires.

One prior art method of solving the problems of wire bonds is the flip chip. Solder balls act as attachment material that allows the flip chip to be attached to a substrate or circuit board. The silicon of the flip chip usually has a different coefficient of thermal expansion (CTE) than that of the substrate or circuit board. The CTE for the silicon flip chip can be as low as 3 parts per million (PPM) while the circuit board (as well as the solder balls) can be in the range of 18-22 PPM. As a result of the CTE mismatch, the chip and circuit board expand and contract at different rates due to thermal cycling. A lack of compliance in the contact area can cause failures. Attempts to solve the CTE mismatch have included introducing large volumes of solder. This is contrary, however, to the desires of the market for electronic packaging for smaller, cheaper, and faster components. For example, in U.S. Pat. No. 6,441,487, the inventors specify a minimum sized solder ball that is 229 um (0.009″) as a means of improving reliability. The market is seeking the ability to use solder balls smaller than 100 um (0.004″).

U.S. Pat. No. 6,051,489 presented a circuit package which addressed CTE mismatch by providing lead connections that are not directly on the surface of the die, but instead are formed on posts composed of an encapsulant material. This allows for some compliancy and smaller bond pads or junction areas on the die and thus minimizes the stress on the die surface. Nevertheless, smaller silicon area, greater flexibility, and greater compliancy are still desired.

### SUMMARY

A method and apparatus are described for an electronic component package. A standoff is formed on an active side of a substrate. This substrate has an electronic circuit. A conductive layer is deposited over at least a portion of the standoff and a portion of the active side of the substrate. The conductive layer electrically couples a contact area on the active side of the substrate. The standoff is removed to create a flexible conductor.

Other features and advantages of embodiments of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements, and in which:

FIG. 1 illustrates a wafer on which an embodiment of the invention may be implemented.

FIG. 2 illustrates a die with contact points.

FIG. 3 illustrates the die with a first passivation layer.

FIG. 4 illustrates the die with formed standoffs.

FIG. 5 illustrates the die with metal beams over the formed standoffs and contact points.

FIG. 6 illustrates the die with the flexible contacts after the standoffs have been removed.

FIG. 7 illustrates the die after the application of a coating layer on the top-side of the circuit and an encapsulant on the bottom-side of the circuit.

### DETAILED DESCRIPTION

A method and apparatus are described for an electronic component package using wafer level processing and flexible contacts on the top side of the substrate over an active or passive circuit.

A temporary standoff is formed from the front of the substrate. The electronic device contact areas are exposed. The exposed contacts and standoffs are covered with conductive material which is photoformed into individual contact to standoff conductors. After photoforming the conductors, a portion of the standoff layer is removed, releasing the formed conductors, resulting in a flexible contact. Once the floating flexible conductor is formed and the device is soldered to a circuit board, the conductor will flex to absorb the size changes resulting from the mismatch of coefficients of thermal expansion.

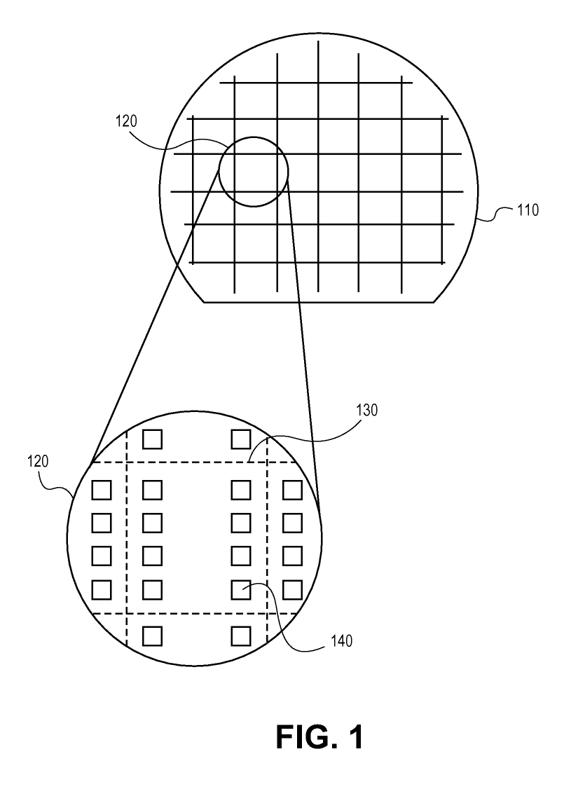

FIG. 1 illustrates a wafer with which embodiments of the present invention may be implemented. Wafer 110 is an electronic component wafer containing a fully processed electronic component. The electronic component can include an integrated circuit, an integrated passive network, or a discrete component. Wafers of various sizes may be used. One area 120 of the wafer 110 is expanded for a better image. The area 120 contains one electronic component 130, which is delineated in FIG. 1 by dashed lines. In actual implementation, no such lines are visible. The electronic component 130 contains a plurality of contact pads 140. Such contact pads are be made of a metal—e.g., aluminum or copper. Further processing steps illustrate the electronic component 130 as it is processed.

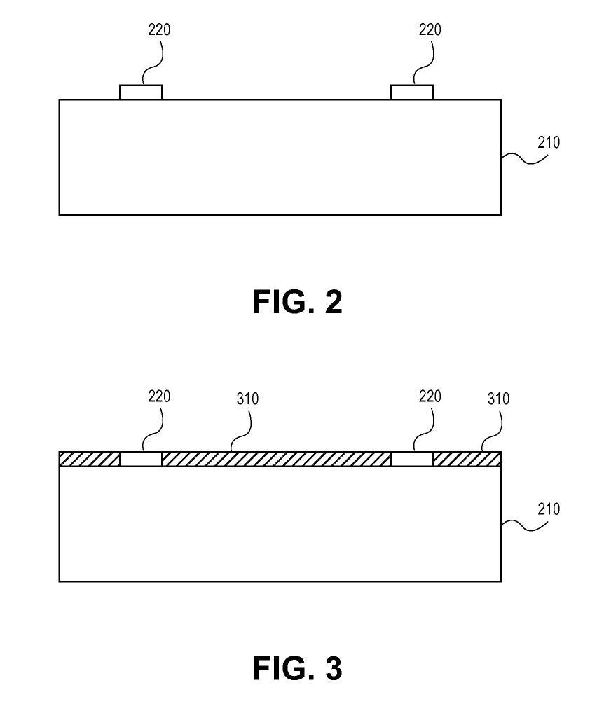

FIGS. 2-7 show the processing of an electronic component. For one embodiment the processing illustrated below occurs at a wafer level prior to the separation of the wafer into individual dies. Wafer level packaging is advantageous because it permits processing to occur simultaneously for multiple dies and does not require individual handling of the dies. Furthermore, because the dies are prepared in the same process, uniformity of processing is assured. The figures below illustrate a single die. Nevertheless, it is understood that the processing is wafer level and occurs with respect to all dies on the wafer substantially simultaneously.

FIG. 2 illustrates an electronic component die. For one embodiment, the electronic component is an integrated circuit, an electronic circuit, an active discrete electronic component, a passive discrete electronic component, or another similar device. The die 210 is a processed electronic component with one or more contact points 220 on a substrate. The substrate may be silicon, gallium arsenide, silicon germanium, silicon carbide, gallium phosphide, ceramic materials, sapphire, quartz, or other substrate materials. The contact points 220 are bonding pads, or similar sites. For one embodiment, the contact points 220 are aluminum. Alternatively the contact points 220 are copper or any other conductive metal.

FIG. 3 illustrates a die with a first passivation layer 310. The passivation layer 310 is deposited by spinning, vapor deposition, or other known methods. For one embodiment, the passivation layer 310 is polyimide. Alternately, the passivation layer 310 is made of silicon nitride, silicon dioxide, epoxy, plastic, resin, Teflon, silicon oxide, silicon, polysilicon, amorphous silicon, aluminum, diamond, or other insulating material. The entire circuit is covered by passivation layer 310. The passivation layer 310 is removed from the contact points 220 by etching. Alternatively, the passivation layer 310 is deposited using masking, and which leaves the contact points 320 exposed. For one embodiment, the present packaging process starts at this point. The first passivation layer 310 is deposited during the formation of the electronic component.

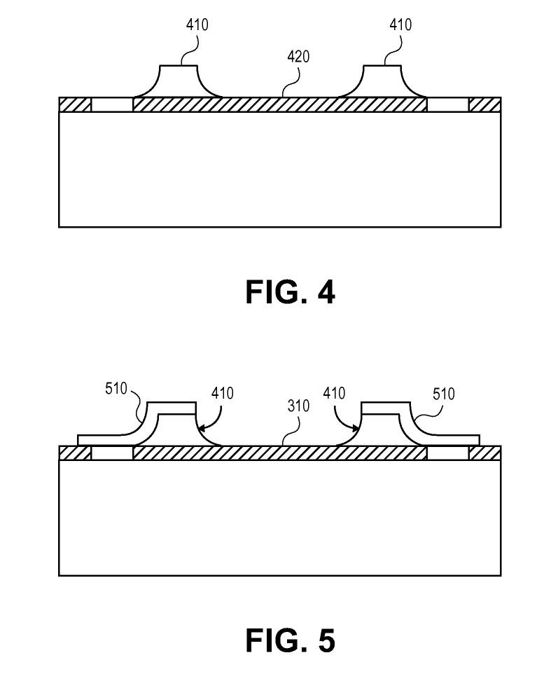

FIG. 4 illustrates a die with formed standoffs 410 according to an embodiment of the present invention. Standoffs 410 serve as temporary stand-offs to support the formation of the flexible conductors described herein and can be easily etched away or otherwise removed once the flexible conductors have been formed. For one embodiment the standoffs 410 are formed by depositing a polymer, such as polyimide, through a stencil. For an alternative embodiment, standoffs 410 are photoformed from an encapsulant or other material such as polymer, plastic, metal, etc. Standoffs 410 may be formed as described above, grown, prefabricated and attached, or made by other means known in the art. For one embodiment, the standoffs 410 are made of silicon, gallium arsenide, silicon germanium, silicon carbide, gallium phosphide, ceramic materials, sapphire, quartz, or other substrate materials. Alternatively, standoffs 410 are made of polymer plastic, patterned plastic, epoxy, glass, Teflon, silicon dioxide, polysilicon, or any other material which can provide mechanical support for the conductive layer described herein. Standoffs 410 are positioned adjacent to or near, but not completely covering, contact points 220. For one embodiment, standoffs 410 are 25 to 200 microns in height.

FIG. 5 illustrates the die with metal beams 510. Metal beams 510 are formed over the passivation layer 310, standoffs 410, and are electrically coupled with contact points 220. The metal beams 510 are deposited in order to lead the contact points 210 to a location on top of the standoff, as will be described below. The metal beams 510 may end at the inside edge of standoffs 410, or the metal beams 510 may fully or only partially cover the respective bottom surfaces of standoffs 410. The bottom surface dimensions of metal beams 510 can vary. It is not necessary for any metal beam 510 to have the same width or the same length as any other metal beam 510. The inter-metal beam pitch can be variable. The metal beams 510 are made of gold, silver, nickel, titanium, aluminum, copper, platinum, another conductive material, or layers thereof. For one embodiment, metal beams 510 are 4-8 microns in thickness.

For one embodiment, a barrier metal such as titanium tungsten (Ti/W) or titanium tungsten/gold (TiW/Au) is first sputter deposited over the entire circuit prior to depositing the metal beams 510. For one embodiment, prior to depositing the metal beams 510, a barrier metal such as titanium tungsten (Ti/W) is first sputter deposited over the entire circuit and followed by a plating of nickel (Ni) and a flash of gold (Au). Alternatively, copper (Cu) plating is used. The barrier metal provides a barrier layer between metals and enhances adhesion of the metal beams 510. Additionally, the underside of the resulting conductive layer—i.e., metal beams 510—does not accept solder while the top plating layer does accept solder. After the deposition of conductive layer 510, the barrier metal layer is etched away from the remaining areas of the electronic component.

For one embodiment, the metal beams 510 comprise a first gold layer, a nickel layer, and a flash gold layer. For one embodiment, the nickel layer is deposited using electroless deposition—i.e., by chemical reduction. For one embodiment, the first gold layer is 4-8 microns and the nickel layer is 4-6 microns in thickness. The nickel layer is used because the gold layer should not be in contact with solder because it might affect solder joint reliability. The nickel layer, however, is susceptible to oxidization. To avoid oxidization, for one embodiment, a flash gold layer is deposited over the nickel layer.

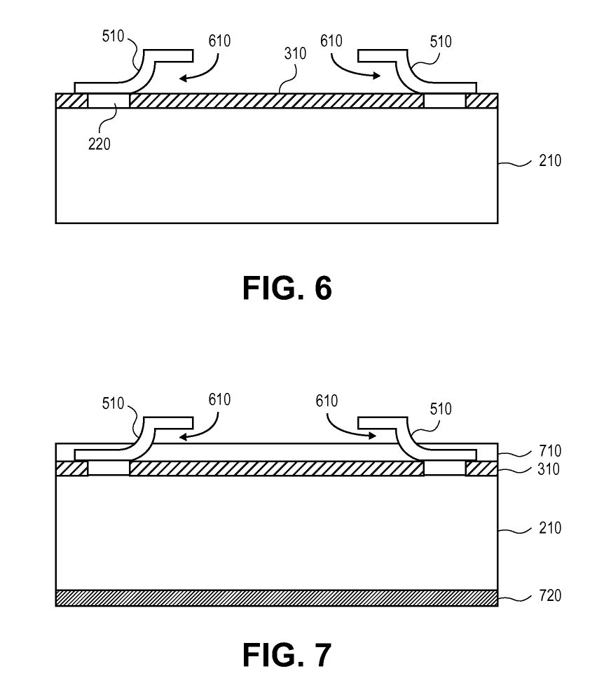

FIG. 6 illustrates the die after the standoffs 410 have been removed from under metal beams 510. Standoffs 410 are removed by exposing the substrate to an etching process such as organic plasma etching or other method known in the art. Once standoffs 410 are removed, air gap 610 defines the space between metal beams 510 and passivation layer 310.

FIG. 7 illustrates the die with flexible connector 510 and coating layer 710. Coating layer 710 resides on top of passivation layer 310. Coating layer 710 is used to cover the metal beams 510, protect the electronic component, and to cover the electrically conductive areas of the circuit. For one embodiment, coating layer 710 is a polyimide layer and is deposited by spinning. Alternatively, the coating layer 710 is another encapsulant or epoxy. For one embodiment, the coating layer 710 is not deposited on the top of the metal beams 510. Thus the tops of the metal beams 510 remain electrically conductive. The coating layer 710 is deposited using a masking process. Alternatively, the coating layer 710 is deposited uniformly over the entire circuit, and removed from the top of beams 510 using photo imaging techniques. For one embodiment, the gap of air between a portion of the contact and a portion of the coating layer 710 is between 10 and 100 microns in height. For one embodiment, this step is omitted.

Coating layer 710 functions as a solder resist. For one embodiment, coating layer 710 is approximately 25 um thick while the standoffs are approximately 25 to 200 um in height. The coating layer 710 surrounds the base of the metal beams 510 and remains under them and over the entire die surface. Any of coating layer 710 that remains on the solder surface of metal beams 510 is so thin that the coating layer is easily penetrated and removed during the reflow solder process joining the package to the circuit board. Nevertheless, the bulk of the coating layer 710 prevents solder form wicking completely over the beam rendering it rigid.

For one embodiment, the back side of the semiconductor substrate is thin. The back side of the semiconductor substrate is thinned to 3-10 mils. Generally, a semiconductor substrate is relatively thick but only has active components on or near the surface. The thickness of the substrate simplifies processing. The semiconductor substrate is thinned by sandblasting, grinding, etching, or other known techniques. The etched back side of semiconductor is a relatively flat semiconductor surface.

FIG. 7 further illustrates the die with an encapsulant 720 on the backside of the electronic component. An encapsulant 720 is used to prevent the danger of the backside of the silicon becoming chipped or otherwise damaged. For one embodiment, the encapsulant 720 is epoxy. Alternatively, other materials may be used. For one embodiment, the area between the individual dies is sawed partially prior to the deposition of the encapsulant 720. This allows the encapsulant to cover the sides as well as the backside of the electronic component.

Once the floating flexible conductor 510 is formed and the device is coupled with a circuit board, the flexible conductor 510 will flex to absorb the expansion and contraction resulting from the mismatch of CTE. For one embodiment, the flexible conductor 510 is patterned to have a suitable surface for coupling with a circuit board via one or more of the following techniques: soldering, ultrasonic bonding, conductive epoxy, or the Occam process. With the Occam process, components are interconnected using copper plating after the components are assembled into their final positions in an encapsulated module. With the Occam process, an assembly containing components is metalized with copper using standard printed circuit build-up processing methods, with circuit patterns created to form the required interconnections between leads of all the components.

As discussed herein, top plating layer of flexible conductor 510 will accept solder—e.g., gold, copper, platinum, nickel, or combination thereof—while the bottom of the flexible conductor 510 will not—e.g., titanium tungsten. If the bottom of the flexible conductor 510 accepted solder, solder would be able to flow or reflow all the way around the flexible conductor 510 due to air gap 610 when being soldered to a circuit board, causing a loss in compliancy. Additionally, for one embodiment, barrier metal 410 exposed by gap 610 is also resistant to solder.

In the foregoing specification, the invention has been described with reference to specific exemplary embodiments thereof. It will be evident that various modifications may be made thereto without departing from the broader spirit and scope of the invention. The specification and drawings are, accordingly, to be regarded in an illustrative sense rather than a restrictive sense.

What is claimed is:

1. A method of making an electronic component package, the method comprising:
forming a standoff on an active side of a substrate, the substrate having an electronic circuit;
depositing a conductive layer over at least a portion of the standoff and a portion of the active side of the substrate, the conductive layer electrically coupling a contact area on the active side of the substrate; and
removing the standoff to create a flexible conductor.

2. The method of claim 1, further comprising:
depositing an insulating layer on the active side of the substrate prior to forming the standoff, wherein the contact area remains exposed.

3. The method of claim 1, wherein the standoff is formed by depositing standoff material through a stencil.

4. The method of claim 1, wherein forming the standoff comprises:
depositing an encapsulant on the active side of the substrate; and
photoforming or etching a portion of the encapsulant to expose the contact area.

5. The method of claim 1, wherein forming the standoff comprises:
attaching a prefabricated standoff.

6. The method of claim 1, wherein the standoff comprises a polymer.

7. The method of claim 1, wherein the standoff is between 25 and 200 microns in height.

8. The method of claim 1, wherein the conductive layer comprises one or more of the following: gold, silver, nickel, titanium, tungsten, aluminum, copper, platinum.

9. The method of claim 1, wherein the conductive layer comprises a top layer to accept solder and a bottom layer to reject solder.

10. The method of claim 1, further comprising:
encapsulating the electronic component package and a second component within a single assembly;
electrically coupling the conductive layer of the electronic component package with a contact on the second component by plating the encapsulated assembly using build-up processing.

11. The method of claim 1, wherein a barrier metal layer is deposited, prior to the conductive layer, on at least a portion of the area to be covered by the conductive layer.

12. The method of claim 1, wherein the standoff is removed by an etching process.

13. The method of claim 1, further comprising:
depositing a second insulation layer on the active side of the substrate after removing the standoff, wherein a portion of the flexible conductor remains exposed.

14. The method of claim 13, wherein the second insulation layer is deposited using a masking process.

15. The method of claim 13, wherein the second insulation layer is deposited uniformly over the entire electronic component package and removed from an upper portion of the flexible conductor.

16. The method of claim 1, further comprising:
depositing an encapsulant on a non-active side of the substrate.

17. The method of claim 1, further comprising:
coupling the flexible conductor with a printed circuit board using one or more of the following: solder, ultrasonic bonding, conductive epoxy, or plated conductors.

18. An electronic component package comprising:
a flexible flange contact on an active side of a substrate, the substrate having an electronic circuit, wherein a gap of air defines the space between a portion of the contact and a portion of the active side of the substrate.

19. The electronic component package of claim 18, further comprising:
an insulating layer on the active side of the substrate between the active side of the substrate and the gap of air and between the active side of the substrate and a portion of the contact, wherein the contact is electrically coupled with the active side of the substrate through the insulating layer.

20. The electronic component package of claim 18, wherein the gap of air between the portion of the contact and the portion of the active side of the substrate is between 25 and 200 microns in height.

21. The electronic component package of claim 18, wherein the contact comprises one or more of the following: gold, silver, nickel, titanium, tungsten, aluminum, copper, platinum.

22. The electronic component package of claim 18, wherein
the electronic component package and a second component is encapsulated within a single assembly, and
the conductive layer of the electronic component package is electrically coupled with a contact on the second component by plating the encapsulated assembly using build-up processing.

23. The electronic component package of claim 18, wherein the contact comprises a top layer to accept solder and a bottom layer to reject solder.

24. The electronic component package of claim 18, further comprising:
a barrier metal layer on the substrate side of the contact.

25. The electronic component package of claim 18, further comprising:
a second insulation layer on the active side of the substrate covering a portion of the contact, wherein the gap of air defines the space between a portion of the contact and a portion of the second insulation layer.

26. The electronic component package of claim 25, wherein the gap of air between a portion of the contact and a portion of the second insulation layer is between 10 and 100 microns in height.

27. The electronic component package of claim 18, further comprising:
an encapsulant on a non-active side of the substrate.
